(19) United States
(12) Patent Application Publication
(10) Pub. No.: US 2024/0072385 A1
(43) Pub. Date: Feb. 29, 2024

(54) POWER SUPPLY INCLUDING A TOUCH SAFE POWER SUPPLY CORE

(71) Applicant: MILWAUKEE ELECTRIC TOOL CORPORATION, Brookfield, WI (US)

(72) Inventors: Samantha L. Billetdeaux, New Berlin, WI (US); Chun Jian Tang, West Allis, WI (US); Mark E. Brouwer, Hartford, WI (US)

(21) Appl. No.: 18/457,884

(22) Filed: Aug. 29, 2023

Related U.S. Application Data
(60) Provisional application No. 63/402,131, filed on Aug. 30, 2022.

(51) Int. Cl. H01M 50/517; H01M 10/42; H01M 50/213; H01M 50/258; H01M 50/296; H01M 50/505; H01M 50/509; H01M 50/583

(52) U.S. Cl. CPC H01M 50/517; H01M 10/425; H01M 50/213; H01M 50/258; H01M 50/296; H01M 50/505; H01M 50/509; H01M 50/583; H01M 2010/4271; H01M 2200/103; H02M 7/003

(57) ABSTRACT

A power supply includes a core housing having a first housing portion and a second housing portion together forming a cavity. The first housing portion is separable from the second housing portion to access the cavity. A battery core includes a plurality of battery cells received within the cavity. The plurality of battery cells are divided into a first group of interconnected battery cells and a second group of battery interconnected cells. The battery core also includes a conductor mechanically and electrically connecting a first terminal of the first group of interconnected battery cells and a second terminal of the second group of interconnected battery cells thereby connecting the first group of interconnected battery cells in series with the second group of interconnected battery cells. The conductor is disconnected from the first terminal or the second terminal when the first housing portion is separated from the second housing portion.

### RELATED APPLICATIONS

This application claims the benefit of U.S. Provisional Patent Application No. 63/402,131, filed Aug. 30, 2022, the entire content of which is hereby incorporated by reference.

### SUMMARY

Gas powered power generators are quickly being replaced by battery-powered power supplies. Battery powered power supplies provide for reduced emissions compared to gas power generators.

Battery powered power supplies (that is, a power supply) include a battery core that includes a plurality of battery cells interconnected to produce a battery core voltage. The battery core voltage can be used to power various kinds of devices connected to the power supply. For example, the battery core voltage may be stepped down to power low-voltage devices through a universal serial bus (USB) outlet. The battery core voltage may be inverted using an inverter to power alternating current (AC) electrical device, for example, power tools, appliances, chargers, and the like.

The battery core voltage may be much higher than widely available battery packs such that the battery core voltage can be used for various purposes as described above. For example, the battery core voltage may be as high as or over 120 Volts. Under normal operating conditions, such a high battery core voltage does not present any risk to an operator as any output point is provided in enclosures or recessed portions inaccessible by the operator. For example, the AC outlet includes recessed electrical terminals that cannot be touched by an operator. However, the power supply may present many touch points if the housing of the power supply is opened, for example, to service the power supply. These touch points may present a risk of electric shock to an operator or servicer if the touch points are at a high voltage potential.

Accordingly, there is a need for touch safe power supply cores.

To reduce the risk of electric shock, many electrical standards, for example, the national fire protection association, or the like list touch safe voltages. These touch safe voltages may vary based on the device, the type of contact, the skill of level of the servicer, and the like. Typically, a voltage potential of below 60 Volts is generally considered touch safe for portable power supply devices. Therefore, reducing the voltage potential of any touch point within the housing of the power supply core may reduce the risk of electrical shock to an operator or servicer.

Battery cores for a power supply described herein include a core housing having a first housing portion and a second housing portion together forming a cavity. The first housing portion is separable from the second housing portion to access the cavity. The battery core also includes a plurality of battery cells received within the cavity. The plurality of battery cells are divided into a first group of interconnected battery cells and a second group of battery interconnected cells. The battery core also includes a conductor mechanically and electrically connecting a first terminal of the first group of interconnected battery cells and a second terminal of the second group of interconnected battery cells thereby connecting the first group of interconnected battery cells in series with the second group of interconnected battery cells. The conductor is mounted to the first housing portion, and the conductor is mechanically and electrically disconnected from at least one of the first terminal and the second terminal when the first housing portion is separated from the second housing portion.

In some aspects, the first group of interconnected battery cells includes a first number of battery cells connected in series and the second group of interconnected battery cells includes a second number of battery cells connected in series.

In some aspects, the first number of battery cells connected in series produce a combined voltage of below 60 Volts (V) and the second number of battery cells connected in series produce a combined voltage of below 60 V.

In some aspects, the battery core also includes a positive power terminal and a negative power terminal for transferring power from the plurality of battery cells. The first group of interconnected battery cells are electrically connected between the positive power terminal and the first terminal and the second group of interconnected battery cells are electrically connected between the second terminal and the negative power terminal.

In some aspects, the battery core also includes a mechanical switch coupled to the conductor and accessible outside the cavity. The actuation of the mechanical switch moves the conductor between a first position in which the conductor is connected to the first terminal and the second terminal, and a second position in which the conductor is disconnected from at least one of the first terminal and the second terminal.

In some aspects, the battery core also includes a first battery management system connected to the first group of interconnected battery cells and a second battery management system connected to the second group of interconnected battery cells.

In some aspects, the conductor includes a fuse.

Battery core for a power supply described herein includes a core housing having a first housing portion and a second housing portion together forming a cavity. The first housing portion is separable from the second housing portion to access the cavity. The battery core includes a plurality of battery cells received within the cavity. The plurality of battery cells are divided into a first battery module having a first group of interconnected battery cells and a second battery module having a second group of interconnected battery cells. The first group of interconnected battery cells are connected in a series-parallel configuration and the second group of interconnected battery cells are connected in a series-parallel configuration. The battery core also includes a conductor mechanically and electrically connecting a first terminal of the first battery module and a second terminal of the second battery module thereby connecting the first battery module in series with the second battery module.

In some aspects, the conductor is mounted to the first housing portion and is mechanically and electrically disconnected from at least one of the first terminal and the second terminal when the first housing portion is separated from the second housing portion.

In some aspects, the first battery module is configured to produce a voltage of below 60 Volts (V) and the second battery module is configured to produce a voltage of below 60 V.

In some aspects, the battery core includes a positive power terminal and a negative power terminal for transferring power from the plurality of battery cells. The first group of interconnected battery cells are electrically connected between the positive power terminal and the first terminal and the second group of interconnected battery cells are electrically connected between the second terminal and the negative power terminal.

In some aspects, the battery core includes a mechanical switch coupled to the conductor and accessible outside the cavity. Actuation of the mechanical switch moves the conductor between a first position in which the conductor is connected to the first terminal and the second terminal and a second position in which the conductor is disconnected from at least one of the first terminal and the second terminal.

In some aspects, the battery core includes a first battery management system connected to the first battery module and a second battery management system connected to the second battery module.

In some aspects, the conductor is provided on an outer side of the core housing.

In some aspects, the conductor is fastened to the first terminal with a first conductive fastener and fastened to the second terminal with a second conductive fastener. The first conductive fastener and the second conductive fastener fasten the conductor to the core housing such that the first housing portion is inhibited from being separated from the second housing portion without electrically disconnecting the first battery module and the second battery module.

In some aspects, the first housing portion includes a conductor pocket formed by a recessed portion. The first conductive fastener, the second conductive fastener, and the conductor are received within the conductor pocket and a cover plate is fixed to the conductor pocket and provides ingress protection and voltage isolation to the conductor.

In some aspects, the conductor includes a high impedance trace switch.

A battery-powered portable power source described herein includes a housing, a power interface on the housing including an alternating current (AC) power output, and a battery core in the housing. The battery core includes a core housing having a first housing portion and a second housing portion together forming a cavity. The first housing portion is separable from the second housing portion to access the cavity. The battery core includes a plurality of battery cells received within the cavity. The plurality of battery cells are divided into a first battery module having a first group of interconnected battery cells and a second battery module having a second group of interconnected battery cells. The first group of interconnected battery cells are connected in a series-parallel configuration and the second group of interconnected battery cells are connected in a series-parallel configuration. The power source includes a conductor mechanically and electrically connecting a first terminal of the first battery module and a second terminal of the second battery module thereby connecting the first battery module in series with the second battery module. The power source also includes an electronics module in the housing and outside the battery core. The electronics module includes an inverter to convert direct current (DC) power from the battery core to AC power provided to the power interface.

In some aspects, the battery-powered portable power source includes a service disconnect switch provided on a current path between the battery core and the electronics module. The service disconnect switch is provided outside the battery core and configured to disconnect the battery core from the electronics module when servicing the battery-powered portable power source.

In some aspects, the battery-powered portable power source includes ingress protection rated connectors configured to connect the battery core to the electronics module.

Battery core for a power supply described herein includes a core housing having a first housing portion and a second housing portion together forming a cavity. The first housing portion is separable from the second housing portion to access the cavity. The battery core includes a plurality of battery cells received within the cavity. The plurality of battery cells are divided into a first group of interconnected battery cells and a second group of interconnected battery cells. The battery core also includes a conductor mechanically and electrically connecting a first terminal of the first battery module and a second terminal of the second battery module thereby connecting the first battery module in series with the second battery module. The conductor is provided on an outer side of the core housing.

In some aspects, the first group of interconnected battery cells are configured to produce a voltage of below 60 Volts (V) and the second group of interconnected battery cells are configured to produce a voltage of below 60 V.

In some aspects, the battery core includes a positive power terminal and a negative power terminal for transferring power from the plurality of battery cells. The first group of interconnected battery cells are electrically connected between the positive power terminal and the first terminal and the second group of interconnected battery cells are electrically connected between the second terminal and the negative power terminal.

In some aspects, the battery core includes a first battery management system connected to the first group of interconnected battery cells and a second battery management system connected to the second group of interconnected battery cells.

In some aspects, the conductor is fastened to the first terminal with a first conductive fastener and fastened to the second terminal with a second conductive fastener. The first conductive fastener and the second conductive fastener fasten the conductor to the core housing such that the first housing portion is inhibited from being separated from the second housing portion without electrically disconnecting the first battery module and the second battery module.

In some aspects, the first housing portion includes a conductor pocket formed by a recessed portion. The first conductive fastener, the second conductive fastener, and the conductor are received within the conductor pocket and a cover plate is fixed to the conductor pocket and provides ingress protection and voltage isolation to the conductor.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

The phrase “series-type configuration” as used herein refers to a circuit arrangement in which the described elements are arranged, in general, in a sequential fashion such that the output of one element is coupled to the input of another, though the same current may not pass through each element. For example, in a “series-type configuration,” additional circuit elements may be connected in parallel with one or more of the elements in the “series-type configuration.” Furthermore, additional circuit elements can be connected at nodes in the series-type configuration such that branches in the circuit are present. Therefore, elements in a series-type configuration do not necessarily form a true “series circuit.”

Additionally, the phrase “parallel-type configuration” as used herein refers to a circuit arrangement in which the described elements are arranged, in general, in a manner such that one element is connected to another element, such that the circuit forms a parallel branch of the circuit arrangement. In such a configuration, the individual elements of the circuit may not have the same potential difference across them individually. For example, in a parallel-type configuration of the circuit, two circuit elements in parallel with one another may be connected in series with one or more additional elements of the circuit. Therefore, a circuit in a “parallel-type configuration” can include elements that do not necessarily individually form a true “parallel circuit.”

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the embodiments will become apparent by consideration of the detailed description and accompanying drawings.

### BRIEF DESCRIPTION OF THE DRAWINGS

FIG. 1 is a perspective view of a power supply in accordance with some embodiments.

FIG. 2 is a perspective view of the power supply of FIG. 1 with a housing removed in accordance with some embodiments.

FIG. 3 is a perspective view of a battery core of the power supply of FIG. 1 in accordance with some embodiments.

FIG. 4 is a perspective view of the battery core of FIG. 3 with a top housing removed in accordance with some embodiments.

FIG. 5 is a perspective view of the battery core of FIG. 3 with a housing removed in accordance with some embodiments.

FIGS. 6A and 6B are plan views of an interior of the battery core of FIG. 3 in accordance with some embodiments.

FIGS. 7A and 7B are plan views of an interior of the battery core of FIG. 3 in accordance with some embodiments.

FIGS. 8A and 8B are block diagrams of the battery core of FIG. 3 in accordance with some embodiments.

FIG. 9 is a block diagram of the battery core of FIG. 3 in accordance with some embodiments.

FIG. 10 is a block diagram of the battery core of FIG. 3 in accordance with some embodiments.

FIG. 11 is a block diagram of the power supply of FIG. 1 in accordance with some embodiments.

FIG. 12 is a block diagram of the power supply of FIG. 1 in accordance with some embodiments.

FIGS. 13A and 13B illustrate an assembly process of the battery core of FIG. 3 in accordance with some embodiments.

FIG. 14 is a block diagram of the battery core of FIG. 3 in accordance with some embodiments.

FIG. 15 is an open side plan view of a cross section of a battery core of the power supply of FIG. 1 in accordance with some embodiments.

FIG. 16 is a top view of a cross section of the battery core of FIG. 15 in accordance with some embodiments.

FIG. 17 is a perspective view of a hinged connection of the battery core of FIG. 15 in accordance with some embodiments.

FIG. 18 is a perspective view of a connector pocket of the battery core of FIG. 15 in accordance with some embodiments.

FIG. 19 is a perspective view of a cover plate of the battery core of the battery core of FIG. 15 in accordance with some embodiments.

### DETAILED DESCRIPTION

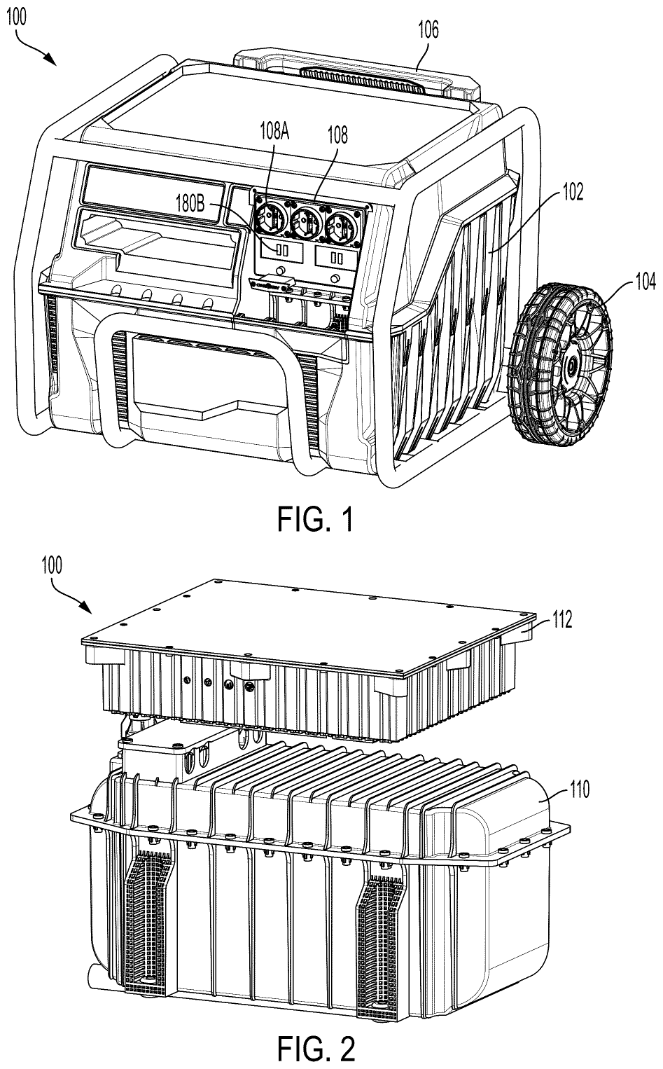

FIG. 1 illustrates a battery-powered portable power supply device or power supply 100. The power supply 100 includes, among other things, a housing 102. In some embodiments, the housing 102 includes one or more wheels 104 and a handle assembly 106. The housing 102 also includes a power interface 108 having one or more alternating current (AC) power outlets 108A and one or more direct current (DC) power outlets 108B. The AC power outlets 108A include, for example, a North American conventional AC power outlet providing 110/120 Volts of output voltage, a European conventional AC power outlet providing 220/240 Volts of output voltage, and/or the like. The DC power outlets 108B include, for example, universal serial bus (USB) outlets, or the like. The power supply 100 also includes a power inlet to receive charging power for charging a battery within the power supply 100. The power inlet may receive AC charging power from a power cord plugged into a wall outlet.

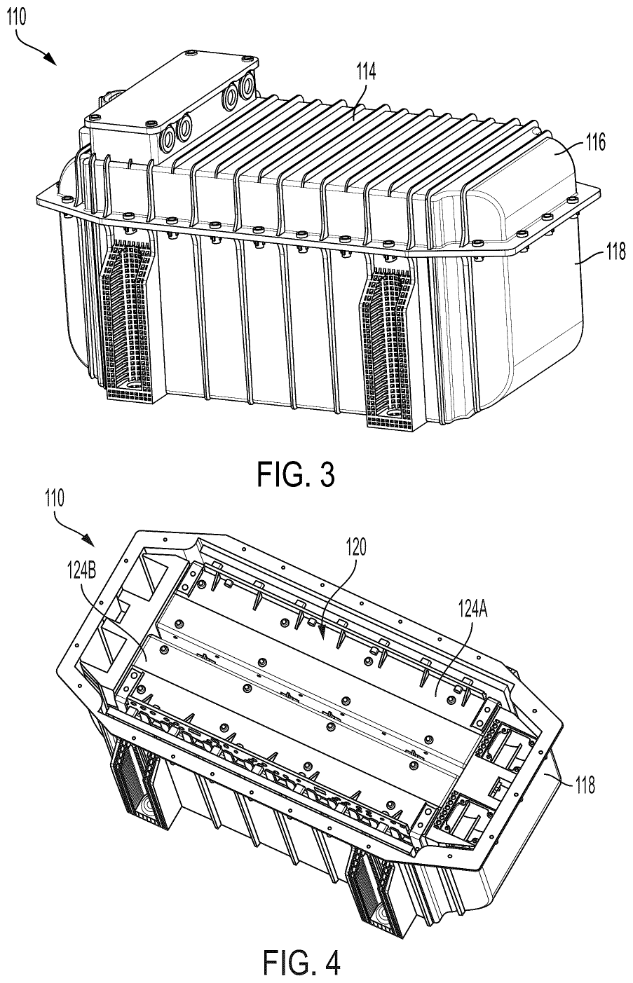

FIG. 2 illustrates the power supply 100 with the housing 102 removed. The power supply 100 includes a battery core 110 and an electronics module 112 (for example, an inverter module) within the housing 102 (for example, within a cavity formed by the housing 102). The electronics module 112 may include the electronic and control circuitry of the power supply 100 including, for example, an inverter, a step down converter, a charging circuit, analog front ends (AFEs), digital front ends (DFEs), battery management system controller, one or more protection circuits, and the like. In some embodiments, the system electronics may be distributed between the battery core 110 and the electronics module 112 with the high voltage potential electronics provided within the battery core 110 and the low voltage potential electronics provided within the electronics module 112. For example, the inverter components may be provided in the electronics module 112 (or the inverter module) and the remaining electronic components may be provided within the battery core 110. In the example illustrated, the electronics module 112 is provided above the battery core 110 with a clearance provided between the electronics module 112 and the battery core 110. The electronics module 112 may be connected to the battery core 110 using one or more wiring modules, terminals, and/or the like.

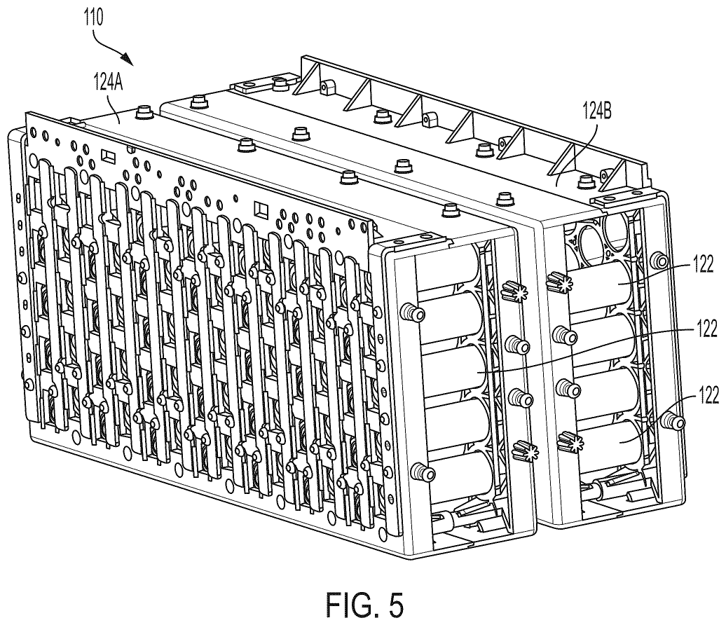

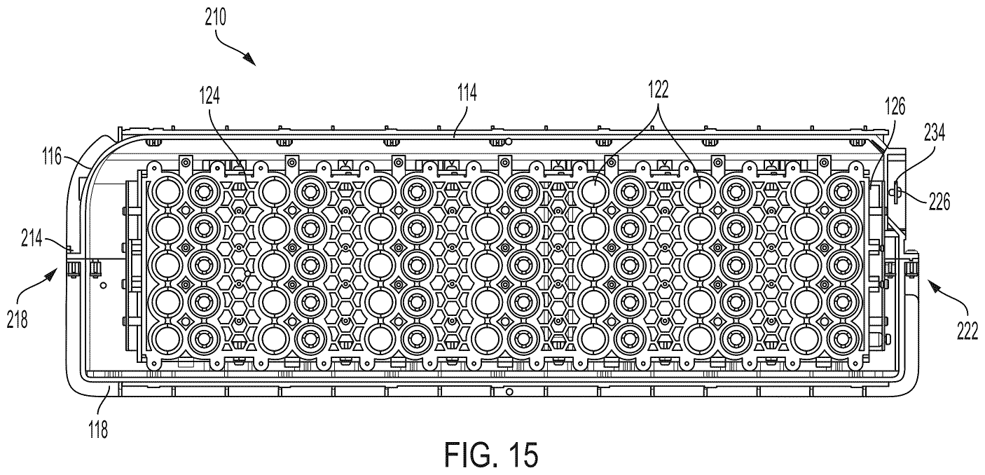

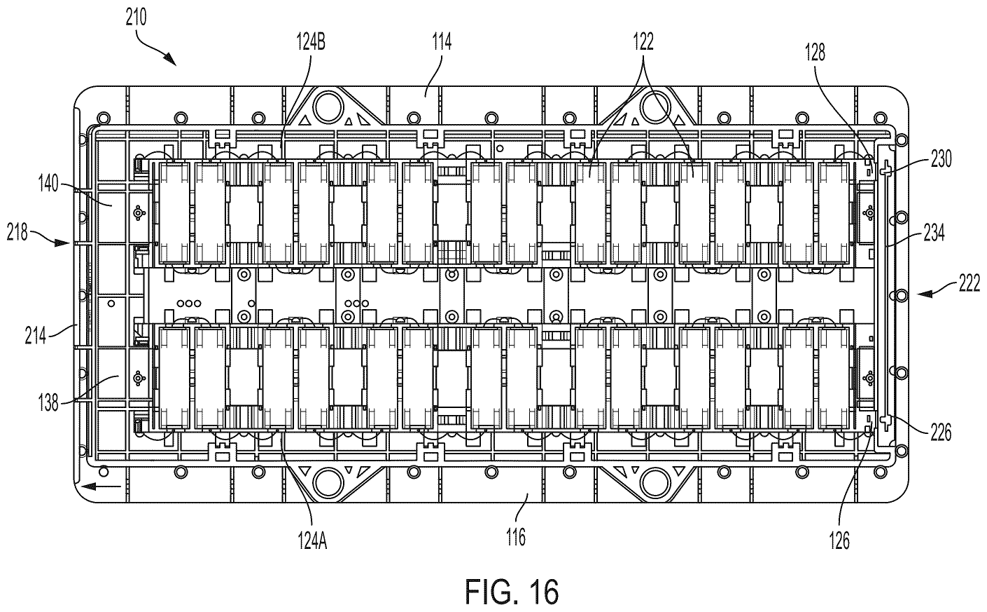

FIGS. 3-5 illustrates one example embodiment of the battery core 110. The battery core 110 includes a core housing 114 having a first housing portion 116 and a second housing portion 118. The first housing portion 116 and the second housing portion 118 together form a cavity 120. The first housing portion 116 is fixed to the second housing portion 118 using, for example, fasteners. The first housing portion 116 is separable from the second housing portion 118 to access the cavity 120. In the example illustrated, the first housing portion 116 is completely separable from the second housing portion 118. In other examples, the first housing portion 116 may be fixed to the second housing portion 118 using a hinged connection such that the first housing portion 116 is partially separable from the second housing portion 118 (for example, see FIGS. 15-17). The first housing portion 116 is separable from the second housing portion 118 by removing the fasteners, for example, by using a tool.

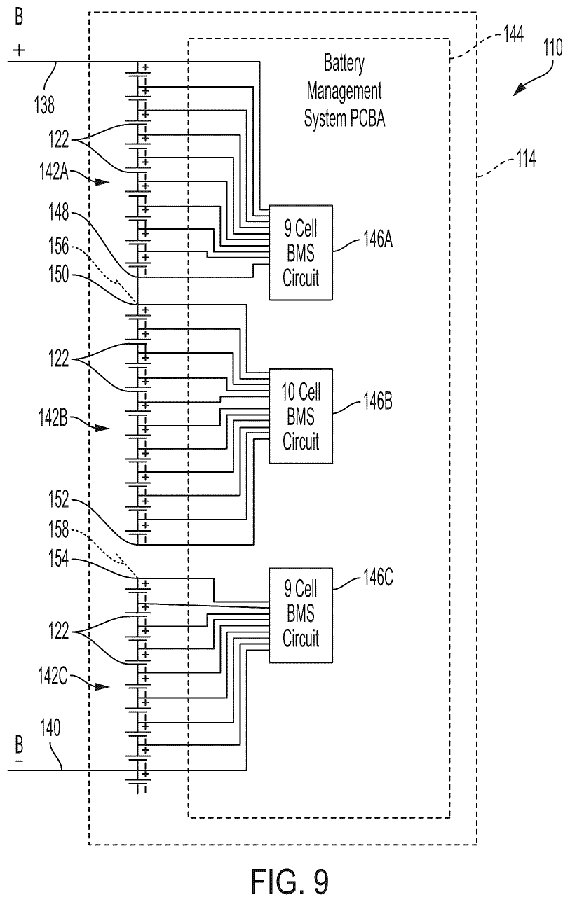

A plurality of battery cells 122 are received within the cavity 120. The battery cells 122 may include cylindrical or prismatic lithium-based (for example, Lithium-ion) battery cells. For example, the battery cells 122 may include 18650, 21700, 30700, 4680, and/or the like Lithium-ion battery cells. In some embodiments, the battery cells 122 are pouch battery cells (e.g., lithium-based pouch battery cells). Each of the battery cells 122 may have a nominal voltage of approximately 3.6 Volts and a maximum voltage of approximately 4.2 volts. Each of the battery cells 122 may have a rated capacity of between 1.2 Ah and 9.0 Ah or more. The plurality of battery cells 122 are divided between a first battery module 124A including a first group of interconnected battery cells 122 and a second battery module 124B including a second group of interconnected battery cells 122. That is, the plurality of battery cells 122 are physically and/or electrically grouped into battery modules 124. The battery core 110 may include additional battery modules 124 that include additional groups of interconnected battery cells 122, for example, as shown in FIG. 9.

Each battery module 124 includes a group of battery cells 122 physically and/or electrically connected together using conductive straps. The group of battery cells 122 in each battery module 124 may be connected in a series-type configuration, a parallel-type configuration, or a series-parallel configuration. In the example illustrated, each battery module 124 has the group of battery cells 122 connected in a 14S5P configuration where 5 strings of battery cells 122 are connected in a parallel-type configuration with each string of battery cells 122 including 14 battery cells 122 connected in a series-type configuration. Based on this configuration, the battery core 110 has a nominal voltage of approximately 100.8 Volts and a maximum voltage of approximately 117.6 Volts. In other examples, each battery module 124 may have a different configuration of battery cells 122. Additionally, the first battery module 124A may have a different number of battery cells 122 in a different configuration than the second battery module 124B.

Industry standards may provide guidelines as to touch safe voltages for industrial electrical devices. For example, the national fire protection association (NFPA) considers a voltage of below 50 Volts as a touch safe or a finger safe voltage. Other standards, which may apply to different classes of devices, may consider different output voltages as touch safe voltages. Additionally, Lithium-ion battery based devices may be further subject to shipping regulations. For example, Lithium-ion battery based devices may not be allowed to be shipped if the devices in the shipped state have an energy capability of greater than 100 Watt-hours. As described above, the battery core 110 may have a voltage potential of between 100.8 Volts and 117.6 volts or more. When the battery core 110 is sealed using the core housing 114, the battery core 110 does not include any touch points that are capable of discharging the full voltage of battery core 110. However, opening the core housing 114 may produce touch points on the battery modules 124 that may result in a potential above a touch safe voltage.

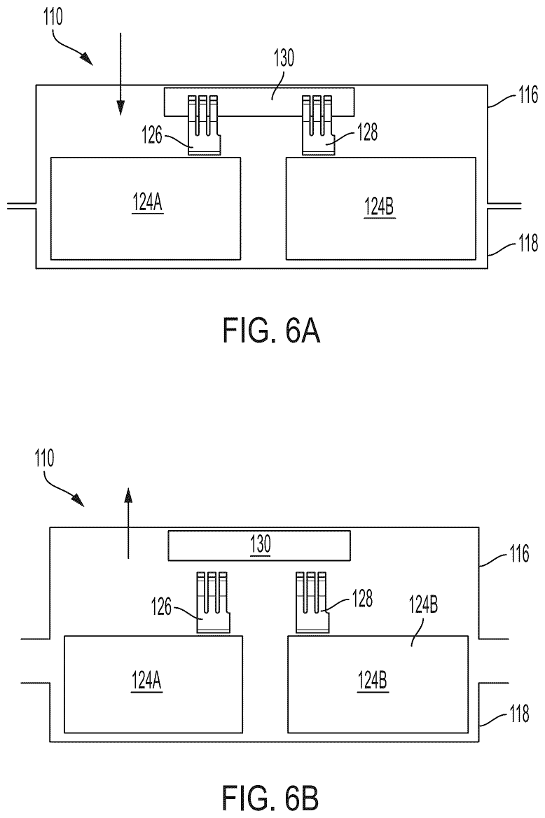

FIGS. 6A-6B illustrates an interior of the battery core 110 including the first battery module 124A and the second battery module 124B. The first battery module 124A includes a first terminal 126 and the second battery module 124B includes a second terminal 128. A conductor 130 mechanically and electrically couples the first terminal 126 and the second terminal 128 to electrically connect the first battery module 124A and the second battery module 124B in series. In the example illustrated, the first terminal 126 and the second terminal 128 are female terminals with the conductor 130 being a male terminal coupling the first terminal 126 to the second terminal 128. In the example illustrated, the conductor 130 is physically mounted to the first housing portion 116. As shown in FIG. 6B, the conductor 130 is mechanically and electrically disconnected from the first terminal 126 and the second terminal 128 when the first housing portion 116 is separated from the second housing portion 118. In some embodiments, the conductor 130 is only mechanically and electrically disconnected from one of the first terminal 126 and the second terminal 128 when the first housing portion 116 is separated from the second housing portion 118.

Each of the battery modules 124 includes a maximum voltage potential of, for example, 58.8 Volts. When the battery core 110 is opened by separating the first housing portion 116 from the second housing portion 118, the conductor 130 electrically disconnects the first battery module 124A from the second battery module 124B. The maximum potential of the battery core 110 is reduced from 118.8 Volts to under a touch safe voltage (for example, under 60 Volts) when the conductor 130 disconnects the first battery module 124A and the second battery module 124B.

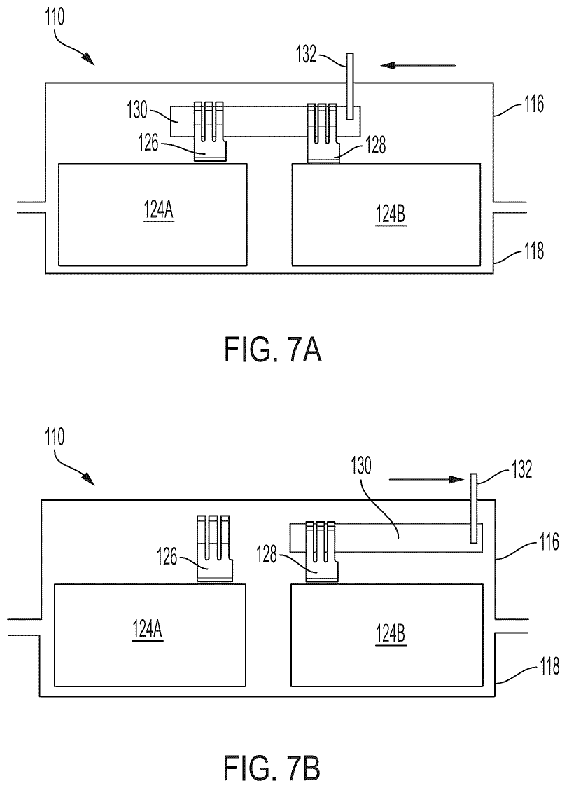

Referring to FIGS. 7A-7B, the battery core 110 may include a mechanical switch 132 coupled to the conductor 130 and accessible outside the cavity 120. The mechanical switch 132 and the conductor 130 may be coupled to move together between a first position (shown in FIG. 7A) and a second position (shown in FIG. 7B) when the mechanical switch is actuated. Referring to FIG. 7A, when in the first position, the conductor 130 is connected to the first terminal 126 and the second terminal 128. Referring to FIG. 7B, in the second position, the conductor 130 is disconnected from the first terminal 126. In some embodiments, the conductor 130 may be disconnected from the second terminal 128 rather than the first terminal 126.

In some embodiments, the battery core 110 may have a different total voltage potential that may be similarly reduced to a touch safe potential by disconnecting two or more battery modules 124. A single conductor 130 or multiple conductors 130 may be used to connect and disconnect the battery modules 124 of the battery core 110 (for example, as shown in FIG. 9).

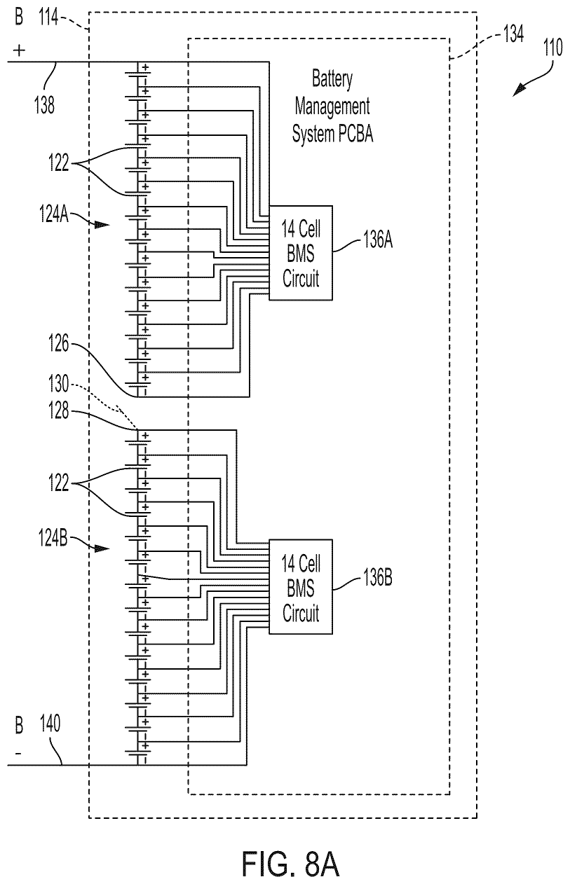

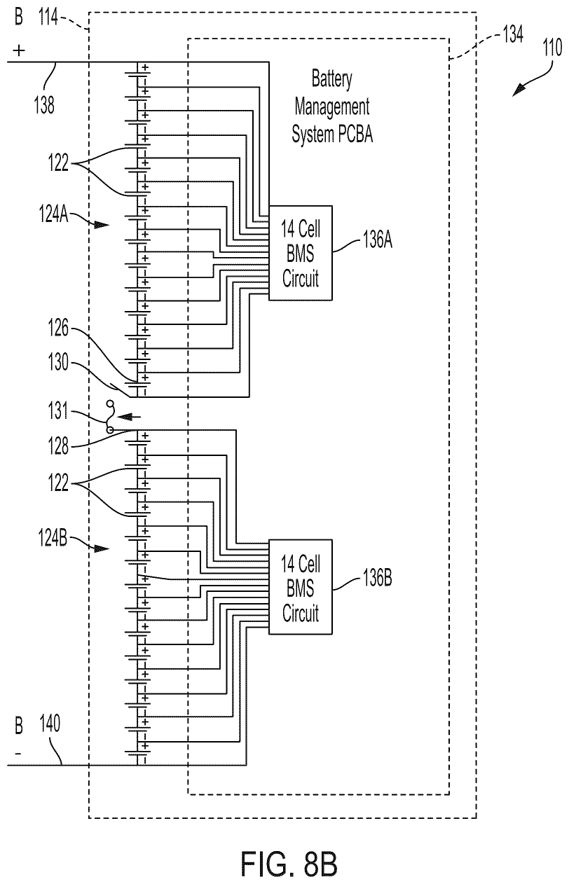

FIGS. 8A and 8B are simplified block diagrams of one example embodiment of the battery core 110. In the example illustrated, the battery core 110 includes the plurality of battery cells 122 divided into two groups of interconnected battery cells 122, that is, a first battery module 124A and a second battery module 124B. In the illustrations of FIGS. 8A and 8B, each battery module 124 is shown as including 14 cells connected in a series-type configuration for simplifying the disclosure. Each battery module 124 may include any number of battery cells 122 connected in one or both of a series-type configuration and a parallel-type configuration. The battery core 110 also includes a battery management system (BMS) 134 provided within the core housing 114 of the battery core 110. The battery management system 134 includes a first battery management system circuit 136A and a second battery management system circuit 136B. The first battery management system circuit 136A is electrically connected to the battery cells 122 of the first battery module 124A. The second battery management system circuit 136B is electrically connected to the battery cells 122 of the second battery module 124B. The first battery management system circuit 136A and the second battery management system circuit 136B may include monitoring circuits, for example, analog front ends (AFEs), digital front ends (DFEs), or the like that individually monitor each battery cell 122. Each battery management system circuit 136 may include multiple monitoring circuits, for example, one monitoring circuit per string of battery cells 122.

The battery core 110 includes a positive power terminal (B+) 138 and a negative power terminal (B−) 140. The plurality of battery cells 122 are coupled between the positive power terminal 138 and the negative power terminal 140. The positive power terminal 138 and the negative power terminal 140 transfer the power from the plurality of battery cells 122 to the various outlets of the power supply 100 through intermediate circuits (for example, an inverter, a step-down converter, or the like). The first group of interconnected battery cells 122, for example, the group of battery cells 122 of the first battery module 124A are electrically connected between the positive power terminal 138 and the first terminal 126. The second group of interconnected battery cells 122, for example, the group of battery cells 122 of the second battery module 124B are electrically connected between the second terminal 128 and the negative power terminal 140. The conductor 130 can selectively connect the first terminal 126 and the second terminal 128 to connect the first battery module 124A and the second battery module 124B in series. As shown in FIG. 8, the conductor 130 is provided entirely within the core housing 114. Referring to FIG. 8B, the conductor 130 may also include a fuse 131. The fuse 131 may disconnect the battery modules 124 in the case of an overcurrent or other over condition. The fuse 131 may have a maximum continuous current rating of at least 150 Amperes. In some embodiments, the fuse 131 may have a maximum continuous current rating of at least 240 Amperes. The conductor 130 and/or the fuse 131 may have a voltage rating of at least 150 Volts DC.

FIG. 9 is a simplified block diagram of one example embodiment of the battery core 110. In the example illustrated, the battery core 110 includes the plurality of battery cells 122 divided into three groups of interconnected battery cells 122, that is, a first battery module 142A, a second battery module 142B, and a third battery module 142C. In the illustration of FIG. 9, each battery module 142 is shown as including either 9 or 10 cells connected in a series-type configuration for simplifying the disclosure. Each battery module 142 may include any number of battery cells 122 connected in one or both of a series-type configuration and a parallel-type configuration. The battery core 110 also includes a battery management system (BMS) 144 provided within the core housing 114 of the battery core 110. The battery management system 144 includes a first battery management system circuit 146A, a second battery management system circuit 146B, and a third battery management system circuit 146C. The first battery management system circuit 146A is electrically connected to the battery cells 122 of the first battery module 142A. The second battery management system circuit 146B is electrically connected to the battery cells 122 of the second battery module 142B. The third battery management system circuit 146C is electrically connected to the battery cells 122 of the third battery module 142C. The first battery management system circuit 146A, the second battery management system circuit 146B, and the third battery management system circuit 146C may include monitoring circuits, for example, analog front ends (AFEs), digital front ends (DFEs), or the like that individually monitor each battery cell 122. Each battery management system circuit 146 may include multiple monitoring circuits, for example, one monitoring circuit per string of battery cells 122.

A first group of interconnected battery cells 122, for example, the group of battery cells 122 of the first battery module 142A are electrically connected between the positive power terminal 138 and a first terminal 148. A second group of interconnected battery cells 122, for example, the group of battery cells 122 of the second battery module 142B are electrically connected between a second terminal 150 and a third terminal 152. A third group of interconnected battery cells 122, for example, the group of battery cells 122 of the third battery module 142C are electrically connected between a fourth terminal 154 and the negative power terminal 140. A first conductor 156 can selectively connect the first terminal 148 and the second terminal 150 to connect the first battery module 142A and the second battery module 142B in series. A second conductor 158 can selectively connect the third terminal 152 and the fourth terminal 154 to connect the second battery module 142B and the third battery module 142C in series. In some embodiments, the first conductor 156 and the second conductor 158 operate together to connect the first battery module 142A, the second battery module 142B, and the third battery module 142C together in series. As shown in FIG. 9, the first conductor 156 and the second conductor 158 are provided entirely within the core housing 114. Similar to the conductor 130 of FIGS. 6A-7B, the first conductor 156 and the second conductor 158 may be mounted to the first housing portion 116 such that the first conductor 156 and the second conductor 158 disconnect the battery modules 142A-142C when the first housing portion 116 is separated from the second housing portion 118.

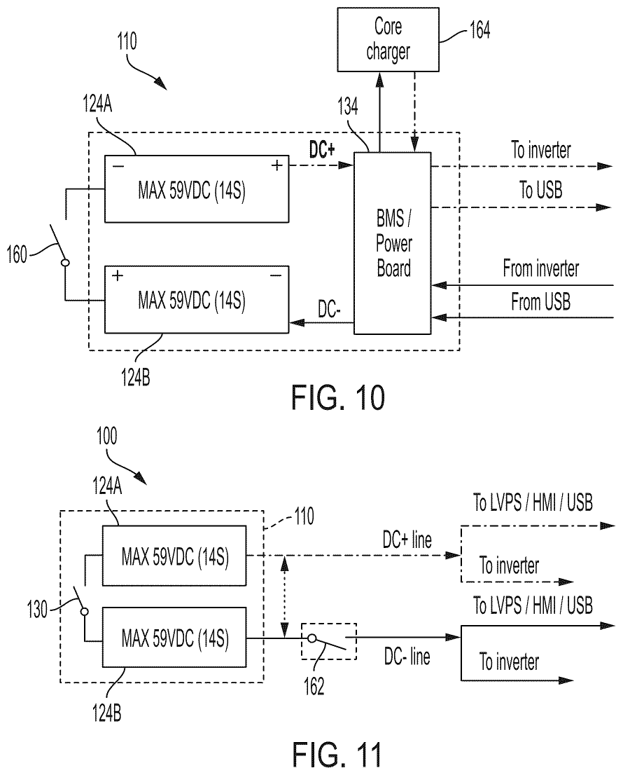

FIG. 10 is a simplified block diagram of one example embodiment of the battery core 110. The example illustrated in FIG. 10 is similar to the example illustrated in FIGS. 8A and 8B, but with a conductor 160 connecting the battery modules 124A and 124B provided outside the core housing 114. The conductor 160 may be provided, for example, in a separate touch safe housing. A mechanical switch accessible outside the touch safe housing may be provided to connect and disconnect the battery modules 124A and 124B.

FIG. 11 is a simplified block diagram of one example embodiment of the power supply 100. In the example illustrated, the battery core 110 includes the battery modules 124A and 124B and the other electronic components, for example, an inverter, a low-voltage power supply, a step-down converter, a human-machine interface, and the like are provided in the electronics module 112. As shown in FIG. 11, a service disconnect switch 162 is provided in addition to the conductor 130. The service disconnect switch 162 may include an electrical switch (for example, a metal oxide semiconductor field effect transistor [MOSFET]) or a mechanical switch (for example, a relay, a single throw switch, or the like). In some embodiments, the service disconnect switch 162 is connected to the negative power line of the battery core 110, as show in FIG. 11. In other embodiments, the service disconnect switch 162 is connected to the positive power line of the battery core 110. The service disconnect switch 162 allows the battery core 110 to be electrically disconnected from the electronics module 112 when servicing the power supply 100. In some embodiments, the service disconnect switch 162 provides redundancy to the conductor 130 to ensure that the battery core 110 is disconnected.

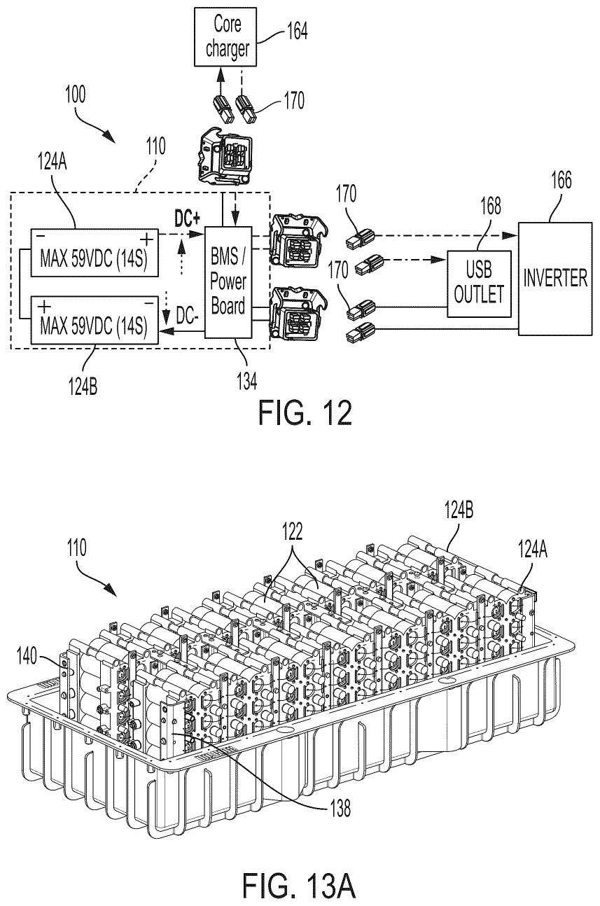

FIG. 12 is a simplified block diagram of one example embodiment of the power supply 100. In the example illustrated, the power supply 100 includes the battery core 110, a core charger 164, an inverter 166, and a USB outlet 168. The battery core 110 includes the battery modules 124A and 124B and the battery management system 134. The battery core 110 may or may not include the conductor 130 for selectively connecting the battery modules 124. The battery core 110 is connected to the core charger 164, the inverter 166, and the USB outlet 168 using ingress protection (IP) rated connectors 170 (e.g., IP64 rated connectors). The IP rated connectors 170 are, for example, shielded connectors.

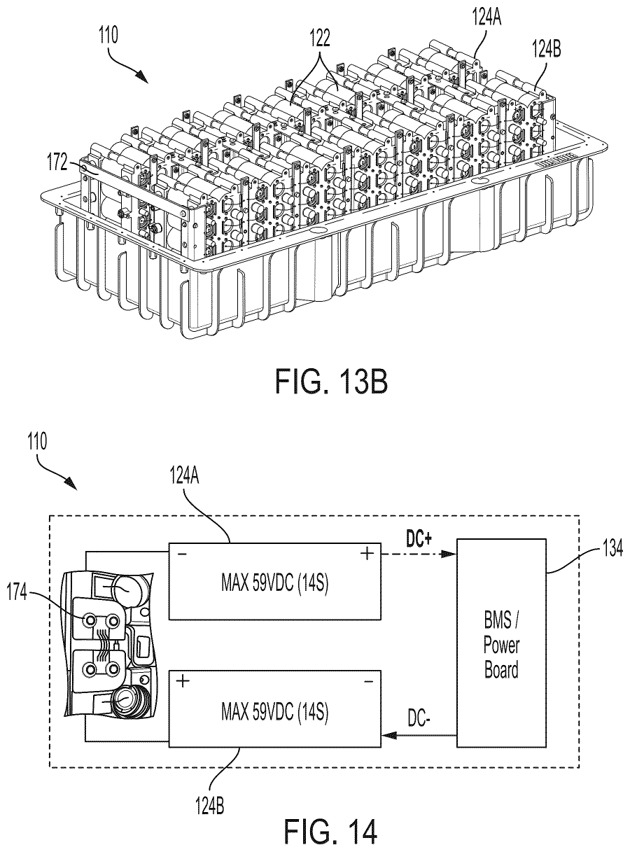

In some embodiments, the battery core 110 may not be rated for servicing. That is, the core housing 114 is not removed to service the battery modules 124. In these embodiments, the conductor 130 may not be needed or modified accordingly. FIGS. 13A and 13B illustrate an example assembly process of a non-serviceable battery core 110. The assembly process includes mechanically fastening the battery modules 124A and 124B together without electrically connecting the battery modules 124A and 124B. The mechanically connected battery modules 124A and 124B are placed in the second housing portion 118. The positive power terminal 138 is connected to the first battery module 124A and the negative power terminal 140 is connected to the second battery module 124B (as shown in FIG. 13A). A bus bar 172 is used to make the final electrical connection between the battery modules 124A and 124B (as shown in FIG. 13B). The battery core 110 is touch safe until the final electrical connection is made between the battery modules 124A and 124B. The first housing portion 116 is then fixed to the second housing portion 118.

FIG. 14 is a simplified block diagram of one example embodiment of the battery core 110. The example illustrated in FIG. 14 is similar to the example illustrated in FIGS. 8A and 8B, but with a high impedance trace switch 174 replacing the conductor 130. The high impedance trace switch 174 is connected between the first housing portion 116 and the second housing portion 118 such that separating the first housing portion 116 from the second housing portion 118 breaks the traces of the high impedance trace switch 174 thereby breaking the electrical connection between the battery modules 124A and 124B.

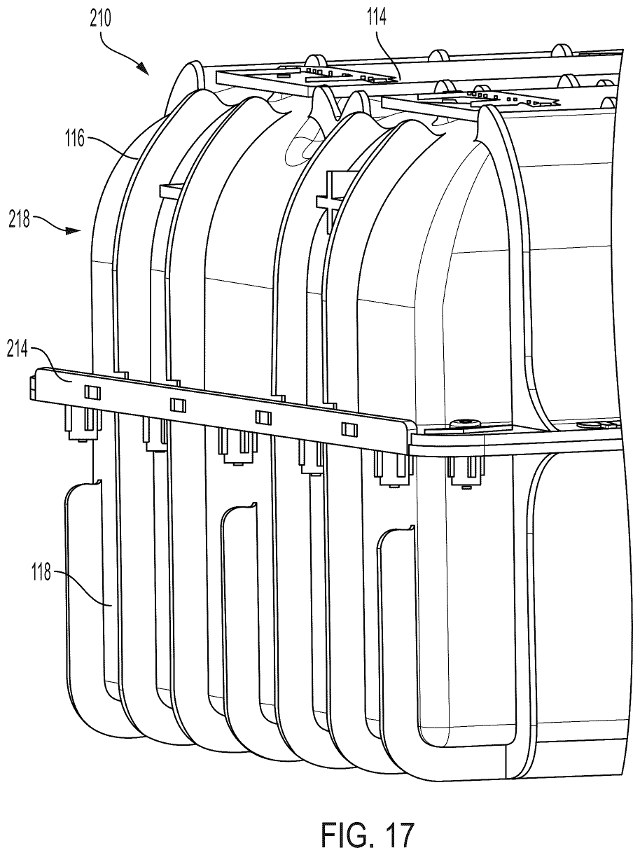

FIGS. 15-19 illustrate one example embodiment of a battery core 210. The battery core 210 is similar to the battery core 110 described above with respect to FIGS. 3-5, and like numerals are used to identify like components and the like components description is omitted here for brevity. The embodiments described above with respect to battery core 110 are interchangeable with the embodiments of battery core 210. In the example illustrated, the first housing portion 116 (for example, a top housing portion) is fixed to the second housing portion 118 (for example, a bottom housing portion) using a hinged connection 214 (see FIG. 17) such that the first housing portion 116 is partially separable from the second housing portion 118. The first housing portion 116 is pivotable about the hinged connection 214 allowing for a pivoting range of, for example, 180 degrees about the hinged connection 214. In some embodiments, a different pivoting range may be provided between the first housing portion 116 and the second housing portion 118.

The hinged connection 214 is provided on a first side 218 of the core housing 114. The positive power terminal (B+) 138 (for example, a global positive terminal) and the negative power terminal (B−) 140 (for example, a global negative terminal) can also be provided on the first side 218. The first battery module 124A and the second battery module 124B are arranged in the core housing 114 such that the first terminal 126 and the second terminal 128 are provided on a second side 222 of the core housing 114 opposite the first side 218. In the example illustrated, the first terminal 126 (for example, a first conductive mounting boss) and the second terminal 128 (for example, a second conductive mounting boss) are implemented as conductive mounting bosses.

The first terminal 126 and the second terminal 128 receive a first conductive fastener 226 and a second conductive fastener 230, respectively. The first conductive fastener 226 and the second conductive fastener 230 fasten the first battery module 124A including the first terminal 126 and the second battery module 124B including the second terminal 128 to the first housing portion 116 and a conductor 234. The first housing portion 116 and the conductor 234 include openings sized to receive the conductive fasteners 226, 230. The conductor 234 may be similar to the conductors 130, 156, 158, 160 discussed above and is provided on the second side 222 of the core housing 114. An electrical connection is formed between the first battery module 124A and the second battery module 124B through the first terminal 126 (for example, the first conductive mounting boss), the first conductive fastener 226, the conductor 234, the second conductive fastener 230, and the second terminal 128 (for example, the second conductive mounting boss). The connection scheme described above inhibits the first housing portion 116 from being partially or fully separated from the second housing portion 118 portion without first disconnecting the first battery module 124A and the second battery module 124B. That is, the mechanical and electrical interlocking described above allows for rendering the battery core 210 touch safe before the battery modules 124 can be accessed. Additionally, prior to installation of the first housing portion 116 to the second housing portion 118, the battery core 210 would be below the touch-safe potential (for example, 60 Volts) during all assembly steps.

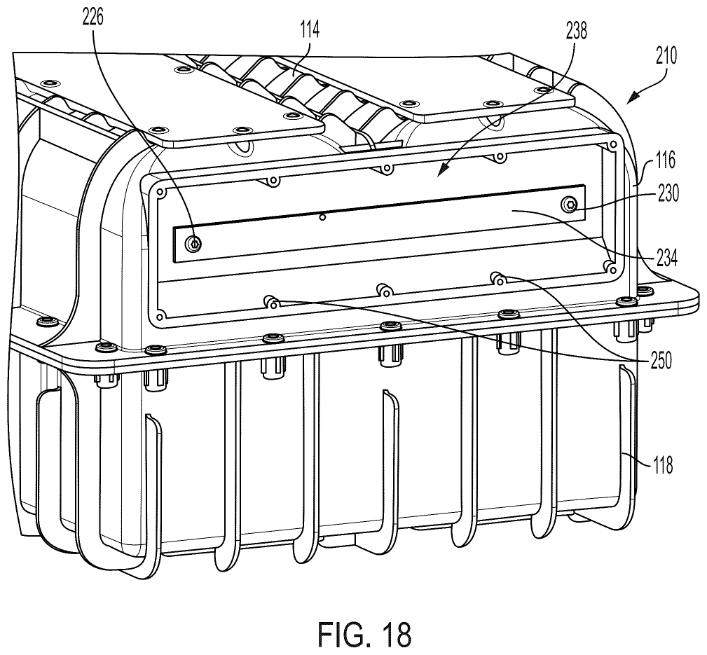

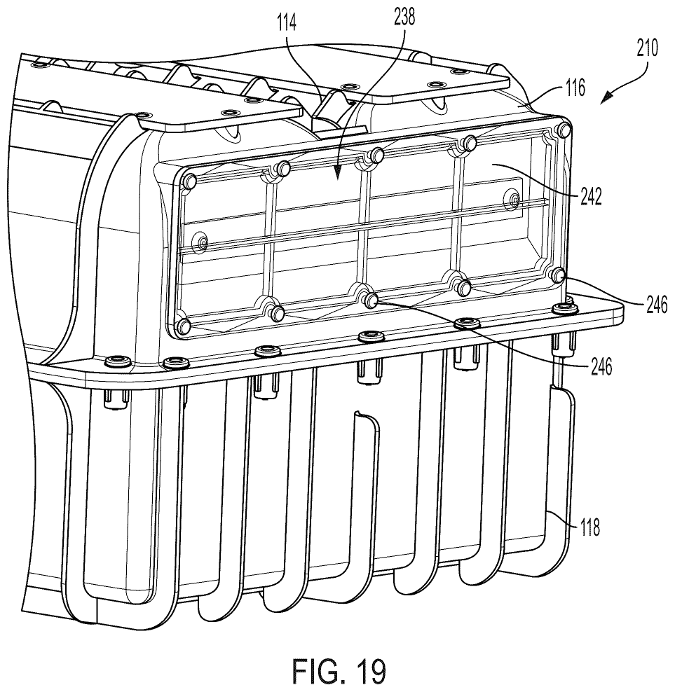

Referring to FIG. 18, the first housing portion 116 includes a conductor pocket 238 that is formed by a recessed portion on the second side 222 of the first housing portion 116. The conductive fasteners 226, 230 and the conductor 234 are received within the conductor pocket 238. Referring to FIG. 19, a cover plate 242 may be provided over the conductor pocket 238. In the example illustrated, the cover plate 242 may be fixed to the conductor pocket 238 using fasteners 246 that are received within mounting bosses 250 of the conductor pocket 238. The cover plate 242 may be fixed to the conductor pocket 238 such that the cover plate 242 provides ingress protection and voltage isolation to the conductor 234. In other examples, a different connection scheme may be used to physically connect the cover plate 242 to the conductor pocket 238. In some embodiments, the conductor pocket 238 and the cover plate 242 may not be provided.

Thus, embodiments described herein provide, among other things, a touch safe power supply core. Various features and advantages are set forth in the following claims.

What is claimed is:

1. A battery core for a power source comprising:
a core housing having a first housing portion and a second housing portion together forming a cavity, the first housing portion separable from the second housing portion to access the cavity;
a plurality of battery cells received within the cavity, the plurality of battery cells divided into a first battery module having a first group of interconnected battery cells and a second battery module having a second group of interconnected battery cells, the first group of interconnected battery cells are connected in a series-parallel configuration and the second group of interconnected battery cells are connected in a series-parallel configuration; and
a conductor mechanically and electrically connecting a first terminal of the first battery module and a second terminal of the second battery module thereby connecting the first battery module in series with the second battery module.

2. The battery core of claim 1, wherein the conductor is mounted to the first housing portion, and wherein the conductor is mechanically and electrically disconnected from at least one of the first terminal and the second terminal when the first housing portion is separated from the second housing portion.

3. The battery core of claim 1, wherein the first battery module is configured to produce a voltage of below 60 Volts (V) and the second battery module is configured to produce a voltage of below 60 V.

4. The battery core of claim 1, further comprising:
a positive power terminal and a negative power terminal for transferring power from the plurality of battery cells,
wherein the first group of interconnected battery cells are electrically connected between the positive power terminal and the first terminal and the second group of interconnected battery cells are electrically connected between the second terminal and the negative power terminal.

5. The battery core of claim 1, further comprising:
a mechanical switch coupled to the conductor and accessible outside the cavity, wherein actuation of the mechanical switch moves the conductor between a first position in which the conductor is connected to the first terminal and the second terminal and a second position in which the conductor is disconnected from at least one of the first terminal and the second terminal.

6. The battery core of claim 1, further comprising:
a first battery management system connected to the first battery module; and
a second battery management system connected to the second battery module.

7. The battery core of claim 1, wherein the conductor includes a fuse.

8. The battery core of claim 1, wherein the conductor is provided on an outer side of the core housing.

9. The battery core of claim 8, wherein the conductor is fastened to the first terminal with a first conductive fastener and is fastened to the second terminal with a second conductive fastener, wherein the first conductive fastener and the second conductive fastener fasten the conductor to the core housing such that the first housing portion is inhibited from being separated from the second housing portion without electrically disconnecting the first battery module and the second battery module.

10. The battery core of claim 9, wherein the first housing portion includes a conductor pocket formed by a recessed portion, wherein the first conductive fastener, the second conductive fastener, and the conductor are received within the conductor pocket, and wherein a cover plate is fixed to the conductor pocket and provides ingress protection and voltage isolation to the conductor.

11. The battery core of claim 1, wherein the conductor includes a high impedance trace switch.

12. A battery-powered portable power source comprising:
a housing;
a power interface on the housing including an alternating current (AC) power output;
a battery core within the housing, the battery core including:
a core housing having a first housing portion and a second housing portion together forming a cavity, the first housing portion separable from the second housing portion to access the cavity, and
a plurality of battery cells received within the cavity, the plurality of battery cells divided into a first battery module having a first group of interconnected battery cells and a second battery module having a second group of interconnected battery cells, the first group of interconnected battery cells are connected in a series-parallel configuration and the second group of interconnected battery cells are connected in a series-parallel configuration;
a conductor mechanically and electrically connecting a first terminal of the first battery module and a second terminal of the second battery module thereby connecting the first battery module in series with the second battery module; and
an electronics module in the housing and outside the battery core, the electronics module including an inverter to convert direct current (DC) power from the battery core to AC power provided to the power interface.

13. The battery-powered portable power source of claim 12, further comprising:
a service disconnect switch provided on a current path between the battery core and the electronics module, wherein the service disconnect switch is provided outside the battery core and is configured to disconnect the battery core from the electronics module when servicing the battery-powered portable power source.

14. The battery-powered portable power source of claim 12, further comprising:
ingress protection rated connectors configured to connect the battery core to the electronics module.

15. A battery core for a power source comprising:
a core housing having a first housing portion and a second housing portion together forming a cavity, the first housing portion separable from the second housing portion to access the cavity;
a plurality of battery cells received within the cavity, the plurality of battery cells divided into a first group of interconnected battery cells and a second group of interconnected battery cells; and
a conductor configured to connect a first terminal of the first group of interconnected battery cells and a second terminal of the second group of interconnected battery cells thereby connecting the first group of interconnected battery cells in series with the second group of interconnected battery cells, wherein the conductor is provided on an outer side of the core housing.

16. The battery core of claim 15, wherein the first group of interconnected battery cells is configured to produce a voltage of below 60 Volts (V) and the second group of interconnected battery cells is configured to produce a voltage of below 60 V.

17. The battery core of claim 15, further comprising:
a positive power terminal and a negative power terminal for transferring power from the plurality of battery cells,
wherein the first group of interconnected battery cells are electrically connected between the positive power terminal and the first terminal and the second group of interconnected battery cells are electrically connected between the second terminal and the negative power terminal.

18. The battery core of claim 15, further comprising:
a first battery management system connected to the first group of interconnected battery cells; and
a second battery management system connected to the second group of interconnected battery cells.

19. The battery core of claim 15, wherein the conductor is fastened to the first terminal with a first conductive fastener and is fastened to the second terminal with a second conductive fastener, wherein the first conductive fastener and the second conductive fastener fasten the conductor to the core housing such that the first housing portion is inhibited from being separated from the second housing portion without electrically disconnecting the first group of interconnected battery cells and the second group of interconnected battery cells.

20. The battery core of claim 19, wherein the first housing portion includes a conductor pocket formed by a recessed portion, wherein the first conductive fastener, the second conductive fastener, and the conductor are received within the conductor pocket, and wherein a cover plate is fixed to the conductor pocket and provides ingress protection and voltage isolation to the conductor.
